(19) United States
(12) Patent Application Publication
(10) Pub. No.: US 2001/0051906 A1
(43) Pub. Date: Dec. 13, 2001

(54) Method and apparatus for distributing documents on an event-triggered basis through a communications network system

(76) Inventor: Jewell Lim Esposito, Sterling, VA (US)

Correspondence Address: Thomason, Moser & Patterson LLP, Attorneys At Law, Suite 100, 595 Shrewsbury Avenue, Shrewsbury, NJ, 07702, US

(21) Appl. No.: 09/847,062

(22) Filed: May 1, 2001

Related U.S. Application Data
(60) Provisional application No. 60/200,840, filed on May 1, 2000.

(51) Int. Cl. G06F 17/60

(52) U.S. Cl. 705/35; 705/36; 705/9

(57) ABSTRACT

A method and apparatus for automatically distributing, recording, monitoring, and re-creating communications to participants of an employee benefit plan, via the Internet or automated application. The method and apparatus include a server having a database containing proprietary plan and plan participant information. A plan sponsor or administrator identifies a plurality of plan rules associated with the plan and plan participant information, and defines a plurality of event triggers associated with the plan rules. The method and apparatus searches for event triggers based upon the plan rules, which are pre-configured into the system. The event triggers are associated with specific plan communications medium. In an instance where an event trigger is initiated the method identifies a particular plan communications medium for viewing by the plan participants, and determines a plan participant recipient listing to receive the plan communications medium. The plan communication medium is automatically provided to client computers' of the listed plan participants via a communications network. The listed participants must access the communications network and confirm having viewed the plan communications medium prior to accessing any other attributes of the plan. Where a listed participant fails to confirm viewing the plan communications medium over the communications network, a hard copy is automatically sent. The invention permits the plan sponsor to execute its fiduciary obligation to ensure delivery and communication of all relevant employee benefit plan documents without human intervention.

### CROSS REFERENCE TO RELATED APPLICATIONS

This application claims benefit of U.S. Provisional Application No. 60/200,840, filed May 1, 2000.

### BACKGROUND OF THE DISCLOSURE

1. Field of the Invention

The invention relates to document delivery, reporting, re-creation, and monitoring systems related to employee benefit plans and human resource (HR) programs such as retirement, health and welfare, stock, fringe, cafeteria, orientation, employment, executive compensation, and the like. In particular, the invention relates to a method and apparatus for delivering, reporting, re-creating, and monitoring documents, for use by the employer, employee, and/or plan service provider, for such plans on an event-triggered basis through an internet-based and/or automated system, which is further consistent and in compliance with federal and state laws and regulations regarding the fiduciary and administrative obligation with respect to electronic communication, delivery, reporting, re-creation, and monitoring of documents as they relate to employee benefit plans.

2. Description of the Background Art

Most employers (private, public sector, tax-exempt, union, and the like) offer retirement and other benefit plans and HR programs that are regulated by federal and state governments. The regulations generally require a plan sponsor to provide certain government agencies, as well as plan participants, timely reports and other documentation regarding plans. A sponsor's failure to deliver, report, track, store, monitor, and re-create plan documents or communications can be a breach of the sponsor's fiduciary duty, thereby subjecting that sponsor to adverse and costly legal exposure from employees, as well as legal and audit exposure from the IRS and other agencies of both federal and state government.

Presently, most of the record keeping and form generation process is performed using a manual system where forms and documents are self-identified (i.e., a human must know that an event has occurred that requires a federally mandated document) and then manually generated and printed on a periodic basis. The documents are then delivered to designated recipients using regular mail, hand, or interoffice delivery. Plan sponsors annually pay billions of dollars annually for iterative manual systems.

Therefore, a need exists in the art for an automated document preparation, delivery, reporting, and monitoring system that has the intelligence to identify in one instant, an event that has occurred with respect to a particular employee benefit plan, a particular employee who must receive a particular document, and a particular manner and time for document delivery. In addition, there is a need in the art for the ability to provide a historical and searchable paperless “paper trail” of the artificial intelligence that was used to transact and fulfill the aforementioned system. Furthermore, a need exists in the art for a system to fulfill the fiduciary, administrative, and federal requirement to timely deliver documents to plan participants and other entities in a secure manner. Moreover, a need exists in the art for a system that can store and re-create any such delivered, reported, and monitored document for the employer, employee, and any service provider to the plan.

### SUMMARY OF THE INVENTION

The invention provides a method and apparatus for providing timely generation and transmission, reporting, monitoring, re-creation of documents using an event-triggered, Internet or automated-based system (e.g., Intranet, local and wide area networks (LAN/WAN)), such that the system is compliant with all federal, fiduciary, and administrative mandates imposed on an employee benefit sponsor. One embodiment of the invention is a system that complies with reporting and disclosure requirements for employee benefit plans, e.g., ERISA, IRS, other federal law and state reporting and disclosure requirements and electronic communications regulations, as they relate to employee benefit plans. The system is advantageous over the prior art since it offers simplified compliance with federal and state rules (through an artificial intelligence that can identify a particular event that has occurred with respect to a particular employee benefit plan, and a particular employee who must receive a particular document and in what manner and when). Furthermore, the system has the ability to provide a historical and searchable paperless “paper trail” of employer, employee, and plan service provider activity. As such, human error is virtually eliminated; audit/legal exposure is lessened and expenses are controlled; potential penalties assessed by a federal court or government agency for non-compliance can be avoided; HR professionals are freed up to focus on other critical business tasks; upwardly spiraling printing, delivering, and document storage costs are contained; and employee morale and satisfaction is improved.

More specifically, the system uses a “tickler file” structure to generate triggering events that ensure timely generation, reporting, monitoring, delivery, and re-creation of documents and notices to plan participants and government agencies, all in compliance with federal, regulatory, fiduciary, and administrative mandates. The system uses a tickler file generation module to prepare tickler files comprising a date/time/event indicator, recipient, a document designator, and the like. Upon a date/time/event occurring, the system prepares electronic mail (e-mail) to a designated recipient and provides a link to a Web-hosted application. A Web-based interface requires confirmation that the notified participant has read selectively linked web pages prior to further interaction with the system. The participant must confirm receipt of any forced delivered document. Once the system has confirmed that a delivered communication has been read, the user is free to retrieve documents, enter information, update information, signature verification, and the like from the system web site. That is, the participant is required to acknowledge, through electronic signature, the forced delivered documents before availing himself of any other attributes of the system.

The system rounds out, and ensure compliance with the employer's federal fiduciary and administrative obligations to ensure delivery to a plan participant (e.g., an employee). Specifically, the system recognizes that a participant has not ever linked to and viewed forced delivered communications (e.g., the participant has deleted the e-mailed link, ignored the message, and/or never accessed the Web). In such instance, the system uses a pre-configured cut-off date to notify HR that a particular participant has not read a necessary document, and subsequently the system, without prompting, converts the document that should have been read into a hard copy and delivers that document to the participant. The system, in one embodiment of the invention, is simply the outsourced technology of in-house benefit plan administration and federal compliance work.

### BRIEF DESCRIPTION OF THE DRAWINGS

The teachings of the present invention can be readily understood by considering the following detailed description in conjunction with the accompanying drawings, in which:

FIG. 1 depicts a high level block diagram of the system of the present invention;

FIG. 2 depicts a block diagram of one embodiment of the system software of the present invention;

FIG. 3 depicts a tickler file format;

FIG. 4 depicts a table providing various categories and subcategories of illustrative communications that are enabled by the present invention;

FIGS. 5A and 5B together depict a flow diagram of an event-triggering process for transmitting documents;

FIGS. 6A and 6B together depict a flow diagram of a document request and delivery process;

FIG. 7 depicts a block diagram of a hierarchical plan structure of the present invention;

FIG. 8 depicts a block diagram of a hierarchy for a participant structure of the hierarchical plan structure of FIG. 7; and

FIG. 9 depicts a block diagram of a hierarchy for an administrative structure of the hierarchical plan structure of FIG. 7.

To facilitate understanding, identical reference numerals have been used, where possible, to designate identical elements that are common to the figures.

### DETAILED DESCRIPTION OF THE INVENTION

One embodiment of the invention permits employee benefit plan sponsors to deliver, report, monitor, re-create, and track federally mandated and routine plan communications through a cost-effective web-hosted and/or automated application, from the perspective of the employee, employer, and plan service provider. The system also forms a human resource department's repository for all federal and state imposed, as well as routine plan communications (creating a necessary historical plan document and employee database). Further, employees can self-service their employee benefit plan and personnel information through electronic means: on a 24-hour basis, 7 days a week, 365 days a year. The system has the intelligence to provide the following:

For a Plan Sponsor:

Automated identification of occurrence of life or other triggering event; identification of affected employee; identification of pertinent document; and timely electronic (or hard copy in the event of non-electronic use) delivery of documents; daily and tabulated status of read/delivered plan communications; tracking of employee activity; permanent records that can be instantly queried, retrieved, and re-created; timely distribution of plan amendments; audit/litigation protection and support; and ability to provide multilingual plans, documents, and other communications.

For a Plan Administrator:

Automated delivery of communications, upon occurrence of life, plant, or other triggering event; daily tabulated status of read and/or delivered plan communications; permanent records that can be queried and retrieved online; timely distribution of plan amendments; audit/litigation support by maintaining strict audit trails of participant activities; quicker benefits enrollment and update capabilities; and reduced number of questions from plan participants.

For a Plan Participant (e.g., Employee):

Personal File Cabinet provides instant access to current and historical plan documents and other communications; on-site and on-line self-service capabilities; retirement savings modeling, with Web links to the plan investment manager; quicker and efficient access to HR personnel.

The invention assists employee benefit plan sponsors with the automated delivery of all federal and state-mandated documents, as well as routine plan communications through an illustrative web-hosted application. The system uses a configurable tickler file intelligence for delivering those mandated documents and communications in a timely manner, via the Internet.

The invention is illustrated as a web-hosted solution with its primary function to assist with the automated delivery, reporting, re-creation, and monitoring of all federal and state-mandated documents as well as routine plan communications that almost 100 percent of the nation's employee benefit plan sponsors currently hand deliver, manually record, and physically store. The system has the capabilities to index, retain, preserve, retrieve, and reproduce electronic records (e.g., by employee, date, type of plan, communication, and the like), and the system surpasses the government's minimum standards relating to electronic communication with respect to employee benefit plans. The system can function as a stand-alone system or on a plan sponsor's existing information technology (IT) infrastructure. Although the system is illustratively described as a web-hosted application system, the system may also be implemented on any communication network such as an Intranet, local and/or wide area networks (LAN/WAN), and the like.

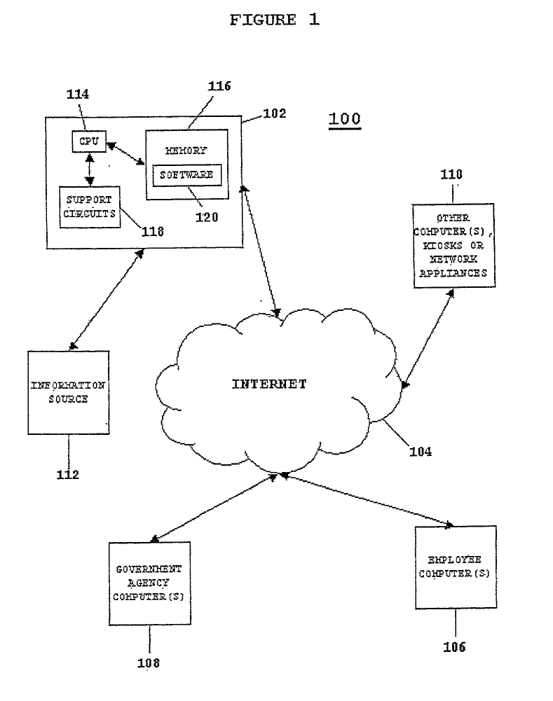

FIG. 1 depicts a high-level block diagram of document delivery system 100 in accordance with the present invention. The system 100 comprises a server 102, the Internet 104, employee computers 106, government agency computers 108, and other computers or network appliances 110. The server comprises a central processing unit 114, memory 116, and support circuits 118. The support circuits 118 include well-known computer circuits such as clocks, cache, input/output circuits, network interface cards, and the like. The memory 116 may include random access memory, read only memory, removable memory, disk storage, and the like. The memory 116 stores the software 120 that causes the server 102 to operate in accordance with the present invention. The server 102 operates as a general purpose server until the CPU 114 executes the software 120 to create a specific purpose server that performs document distribution and other user notification functions of the present invention. The information that is distributed by the system is generally provided by an information source 112 that contains a database of forms, notices, documents, an employee record database, and events pre-programmed and configured by Employee Benefits Consultants who have queried the plan sponsors, plans, and programs. The operation of the system 100 is described in detail below.

The network that interconnects the computers 106, 108, 110 and the server 102 is shown as the Internet 104, but may be any form of communications network capable of propagating documents to particular addresses. Moreover, a user may access the Internet 104, illustratively from a remote hand held device or a home computer, via wireless communications, a modem, or any other communication medium providing Internet access to view documents and use the self-service features.

The system software 120 is organized into three major components, each of which is distributed to a different place or places in the system network. A first layer is a user presentation layer, which supports graphical user interface (GUI) and application-specific entry forms or interactive windows. The user presentation layer is located for example, on the plan participant's client based computer 106 or hand held device. The second layer is a business logic layer, which provides the sets of business rules that the system 100 follows to implement the plan. The business logic layer is located on the server 102 and contains the plan rules and defined triggers to manage document distribution to plan participants. Furthermore, the business logic layer acts as the server for client requests and determines what data is needed, where the data is located, and acts as a client in relation to programming that is located on a different data source. The third layer is a database access layer, which includes the database and programs to manage access to the data.

As described in detail herein, aspects of the preferred embodiment pertain to specific method steps, which may be implemented on computer systems. In an alternative embodiment, the invention may be implemented as a computer program-product for use with a computer system. The programs of the program-product define the functions of the preferred embodiment and may be delivered to a computer via a variety of signal-bearing media, which include, but are not limited to, (a) information permanently stored on non-writable storage media (e.g., read-only memory devices within a computer such as CD-ROM disks readable by CD-ROM drive); (b) alterable information stored on writable storage media (e.g., floppy disks within diskette drive or hard-disk drive 114); or (c) information conveyed to a computer by a communications medium, such as through a computer or telephone network, including wireless communications. Such signal-bearing media, when carrying computer-readable instructions that direct the functions of the present invention, represent alternative embodiments of the present invention.

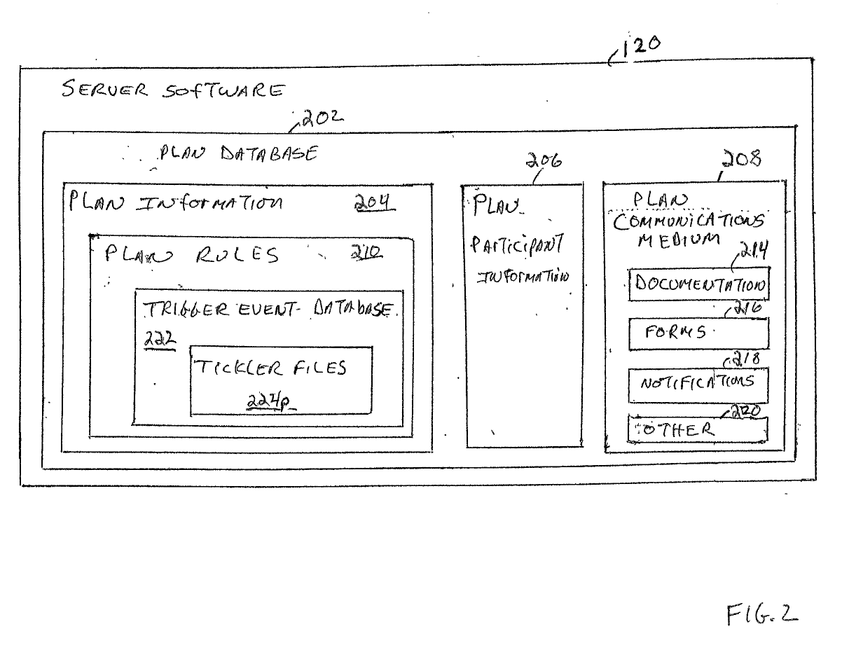

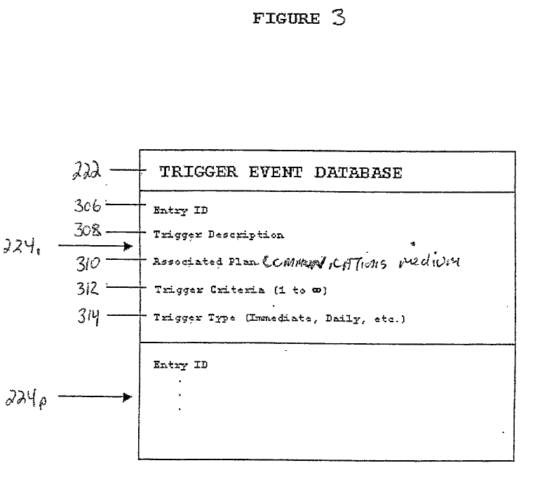

FIG. 2 depicts a block diagram of one embodiment of the system software 120 of the present invention. The system software 120 includes a benefit plan database 202 having plan information 204, plan participant information 206, and plan communications medium 208. The plan information 204 comprises plan rules 210, which are associated with a trigger event database 222 having a plurality of “tickler files” 224ₚ (see also FIG. 3). The plan participant information 206 includes data for each plan participant, such as name, address, date-of-birth, social security number, years of service, job description, beneficiaries, and any other pertinent fact necessary for participating in the plan. The plan communications medium 208 include documents 214, plan forms 216, notifications 218, and other communications 220 deemed pertinent to the plan. The plan communications medium 208 are automatically delivered to the plan participants for their review as discussed below.

The system 100 operates on an event-triggered basis in response to information in the “tickler files” 224. In particular, the software 120 includes a “search engine”, which utilizes a repository of the rules 210, which are plan specific. In particular, the rules 210 are associated with one or more of the event triggers, which generate and automatically deliver the plan communications medium 208 to one or more plan participants, administrators, and the plan sponsor management.

FIG. 3 depicts a tickler file format. In particular, FIG. 3 depicts an illustrative structure for the tickler files 224 within the trigger event database 222 of FIG. 2. These files are produced by Employee Benefit Consultants through interaction with a tickler file creation module. This unique trigger event file is created only after examining specific parameters for each employee benefit plan stored in the system. The trigger event database 222 comprises a plurality of file entries for each tickler file 224₁ through 224ₚ. Each file entry comprises an entry identification (ID) 306 (e.g., a chronological tag created by the system), a trigger description 308 (e.g., an employee's hiring date), an associated plan communications medium 310 such as document or notice identifier (e.g., an employee's enrollment form into a 401(k) plan), trigger criteria 312 (e.g., after three months from date of hire), and a trigger type 314 (e.g., immediate or daily).

Two types of triggers are implemented by the system 100. The first type of trigger is a “program” trigger. Program triggers are computer programs written and scheduled to run at certain times (e.g., hourly, daily, and the like) to perform specific tasks. For example, a program may be written to determine if an employee has greater than six months service, by comparing the employee start date against the current date. If a triggering event (i.e., a business rule) for sending a 401(k) enrollment form after six months of service is implemented into a 401(k) plan, then the program would automatically set up the delivery of the enrollment form to the employee.

The second type of trigger is an “event” trigger. Event triggers are programs designed to launch automatically when some event (e.g., changing a value in a database field) has occurred so that the program can respond to it. For example, if an employee's home address is modified, then the event of changing that field automatically “triggers” the program to identify whether that change is relevant with respect to a delivery of any document under any employee benefit plan or HR program. As such, the event trigger automatically initiates the delivery of Form W-4 because of the change in the employee address field.

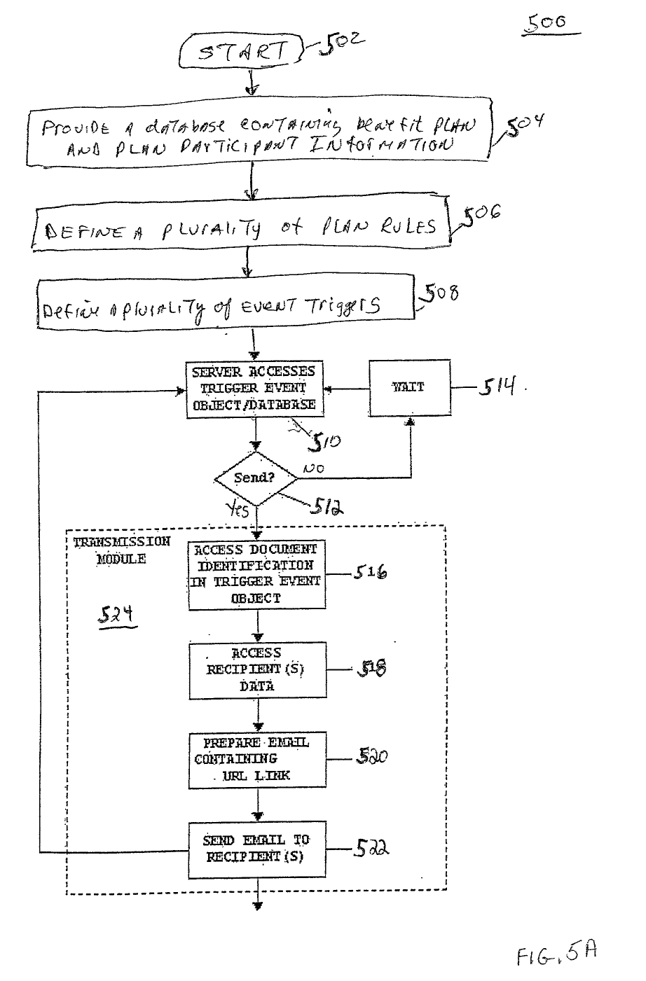

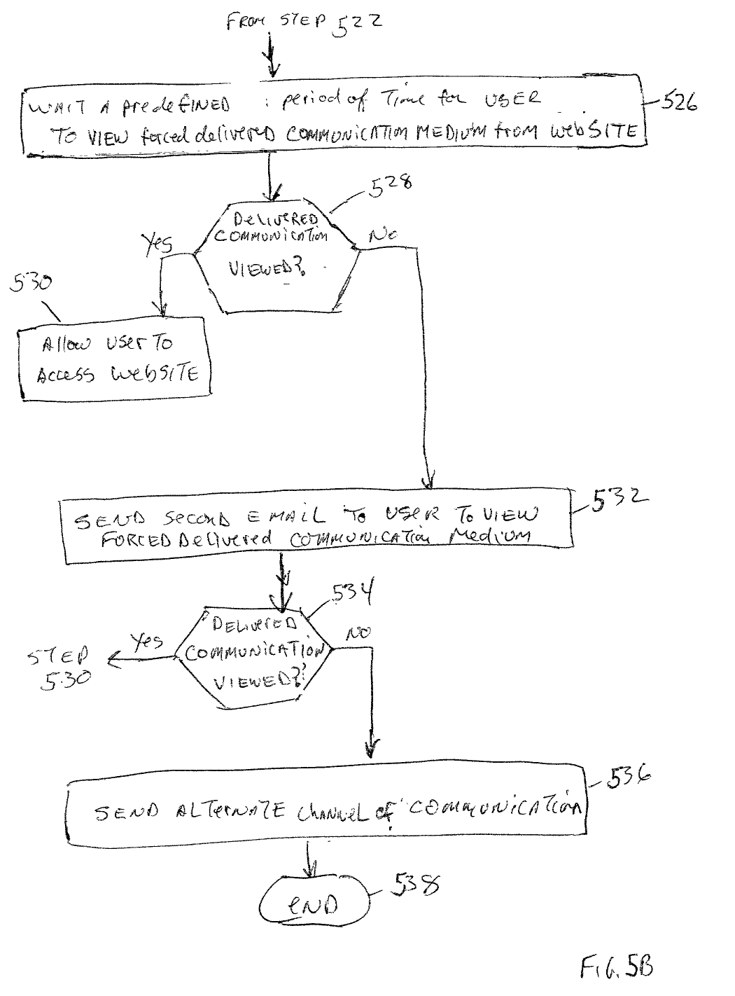

FIGS. 5A and 5B together depict a flow diagram representing the operation of one embodiment of the present invention in an automated notification mode. The automated method 500 operates on an event-triggered basis. Referring to FIG. 5A, the method starts at step 502 and proceeds to step 504 where a unique and proprietary database (per employer) containing benefit plan and plan participant information is stored in the server. In step 506, the plan sponsor and/or administrators define the proprietary plan rules associated with the benefit plan and plan participant information. Furthermore, in step 508, the plan sponsors and/or administrators define event triggers based on the plan rules and the participant information. Once the plan database is defined with all the rules and event triggers, the benefit plan database is ready for operation and interaction for that specific employer. The uniqueness of the system is that the system is employer specific (i.e., capable of identifying the particulars associated with one employer over others). In particular, the system treats each employer on an individual basis based on each employer's respective internal policies and plan rules.

The method 500 proceeds to step 510, where the server accesses a trigger event object. The trigger event object information is inspected to determine if any notices or documents are to be sent to users (e.g., government agencies, plan sponsors, employees, and the like) at this time. In one embodiment, there is a nightly read of plan sponsor and HR databases. The method 300 searches through the databases to determine if certain events have occurred (e.g., someone turns age 35 that night).

The method 500 queries at step 512 whether a transmission is required (e.g., a notice regarding turning 35 years old). If no plan communications medium (e.g., document, form, e-mail notification, report) are to be sent, the method 500 proceeds to step 514 and waits for a predefined period before returning to step 510. If a transmission is required, the method 500 launches a message transmission module 524. In effect, the message transmission module is launched on an event-triggered basis.

The transmission module 524 constructs the plan communication medium that is to be delivered. The transmission module 524 begins at step 516 by accessing the trigger event object entry that has identified a need for transmission. Step 516 identifies the plan communications medium (e.g., document or notice) that requires transmission.

At step 518, the method 500 accesses the recipients' list. Each plan communications medium is formatted to provide relevant information regarding either general information for all the participants, or specific information for a particular participant. For example, communications that are intended for distribution to all the participants have general information provided in a header of the communication. Such general information is stored in various fields of the database and is copied into the body of the communications medium as required. Similarly, information that is specific to a plan participant is copied from various fields in the plan participant database as required, and attached to the body of the plan communications medium to generate a completed communications for delivery.

In step 520, an electronic mail (e-mail) message is prepared. The e-mail includes a link to a web-hosted application where the plan communications medium (e.g., document/notice) can be viewed. At step 522, the e-mail message is sent to the recipients on the recipient list, and the method 500 proceeds to step 526.

Referring to 5B in step 526, the method 500 waits a predefined period of time for each recipient on the list to confirm that each has viewed the appropriate forced delivered communication medium. That is, the user is invited to access selected web pages in the plan web site, which are pertinent to that particular user or participant. In step 528, a determination is made as to whether the user has accessed, acknowledge, and electronically signed an affirmation on the selected plan web pages. That is, if the user fails to go to web-hosted application after a predefined period of time, the system recognizes that the user has not viewed the plan communications medium.

If the determination of step 528 is answered affirmatively, then the method 500 proceeds to step 530, where the user is enabled to access the entire web site that is dedicated to such participant. If, however, in step 528, the determination is answered negatively, then the method proceeds to step 536.

In step 536, an alternate communication channel already pre-configured by the system (e.g., hard copy sent by mail, courier, priority mail, and the like) is used to notify the listed plan participant and/or provide the relevant subject matter (such that the employer's federal, fiduciary, and administrative obligations are carried out without further human invention). Optionally, in steps 532, a second e-mail may be sent to the listed recipient prior to sending the communication by an alternate communication channel. In step 534, the system monitors whether the selected web pages have been viewed. If, in step 534, the determination is answered affirmatively, then the method proceeds to step 530, where the recipient is allowed to view participant related web pages.

If, however, the determination in step 534 is answered negatively, then the method proceeds to step 536 where the alternate communications channel is provided. Once the listed participant has either viewed a event triggered communication or related web pages, or has been sent a hard copy notification or document, the method 500 ends at step 538.

The rules based trigger event system enables the system 100 to automatically present documents to plan participants. In one embodiment, the rules are employed by using simple Boolean algebra to determine if either a program or event trigger should be executed. Using the forgoing trigger event based system, a plan sponsor (e.g., employer) will meet all reporting and disclosure requirement deadlines in an automated manner, once those deadlines are pre-configured by the plan sponsors and system administrators.

Moreover, the programming of the rules is adaptive to for modification, due to changes in the federal and state laws, or other plan changes. As such, the system administrators are enabled to modify the rules as required. For example, a particular ERISA law may change, which requires fewer years of service for an employee to receive a particular benefit. The system administrators are capable of modifying the rule containing such years of service parameter. As such, the plan participants and governmental agencies are able to receive plan documents and communications in a timely and cost effective manner.

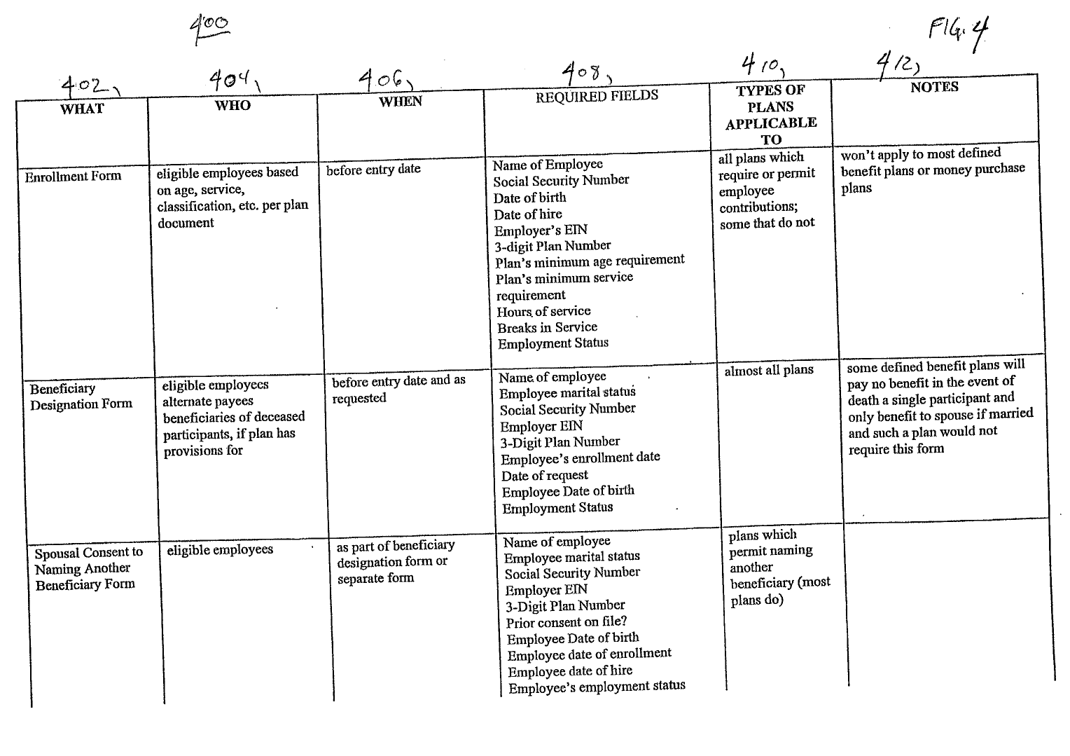

FIG. 4 depicts a table 400 providing various categories and subcategories of illustrative communications that are enabled by the present invention. Table 400 illustratively includes documents/notices, recipients, types of plans that require such notices, and when the document/notice should be sent to the recipients. The table 400 illustratively focuses primarily on retirement plans, but the system 100 can support trigger-event delivered documents and notices for all types of employee benefit plans, and table 400 should not be considered as limiting.

The first column 402 lists a type of form such as an enrollment form, beneficiary designation form, a notification form, and the like. The second column 804 provides for whom the form pertains. For example, the enrollment form shown as the first entry in column 402 pertains to eligible employees based on age, service, classification, and the like. The third column 406 provides when the form is to be completed. For example, the enrollment form is to be completed before the entry date. The fourth column 408 specifies the required fields that must be completed in the form. All forms and notices require participant name, participant social security number, employer's identification number (EIN) and a plan number. Each form or notice also includes additional fields that are specific for the particular form. For example, the enrollment form includes fields for date of birth, minimum age requirement, years of service, and the like. The fifth column 410 provides the types of plans the form or notice is applicable to. For example, the enrollment form is applicable to all plans, which require or permit employee contributions, and some that do not. The sixth column 412 provides administrative notes. For example, the enrollment form does not apply to most defined benefit plans or money purchase plans.

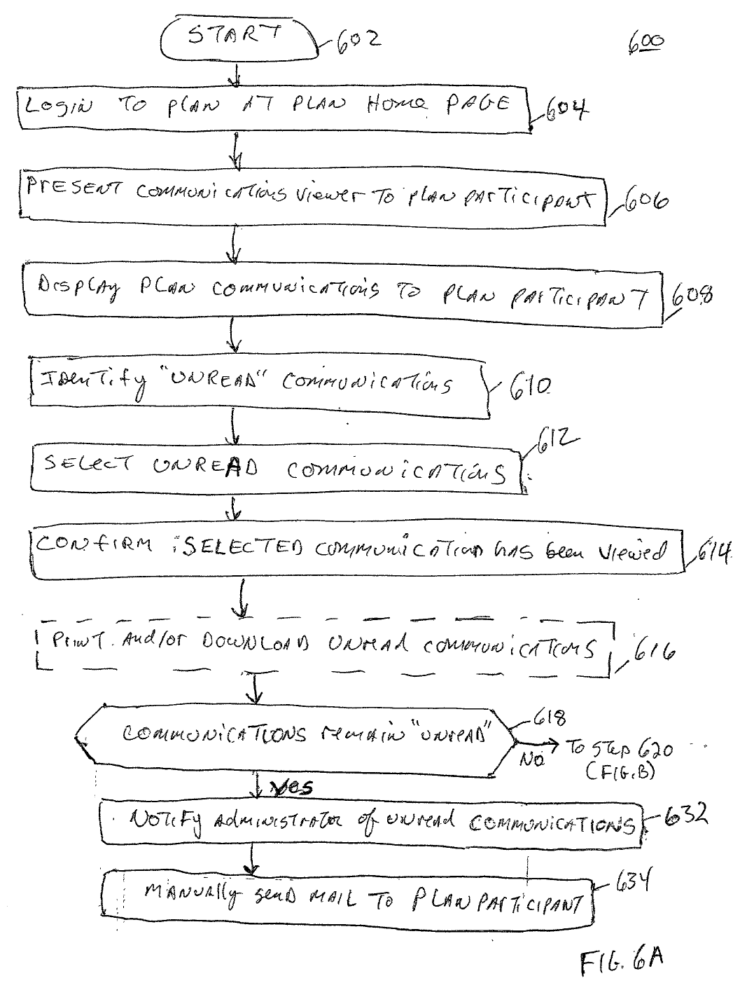

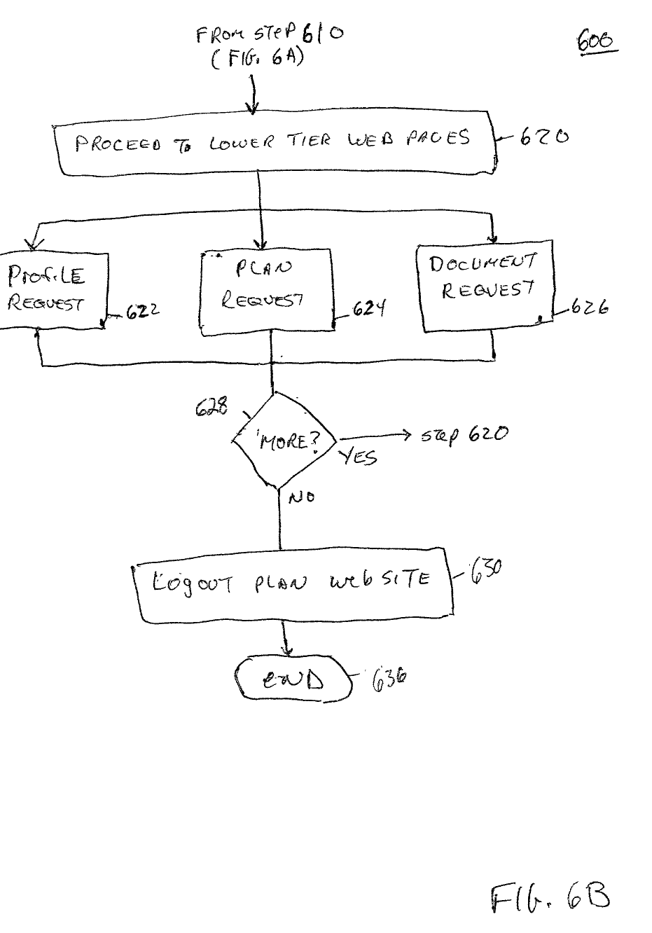

FIGS. 6A and 6B together depict a flow diagram of a document request and delivery process. In particular, FIGS. 6A and 6B depict the operation of the system 100 in an interactive mode. The interactive method 600 begins at step 602 and proceeds to step 604, where a user receives an email to access a plan web site beginning with a plan home page. The web site comprises a user interface, which provides a user with access to view plan information, documentation, and communications offered and sent by the plan sponsor.

The user is presented with the home page of the plan web site, where the user is requested to “logon” to the web site. Logins are tracked, so as to document and archive access, confirmation of receipt, and electronic signature. To ensure authorized access of the web pages, the entire web site or portions thereof may be password protected such that only authorized users may access the information available through the web site. Additional security is provided by minimizing user access rights to an as need basis, as well as authentication mechanisms. For example, there are different access levels for varying management levels at HR (from clerk to manager). Password expiration dates and minimum character length requirements may be implemented. Moreover, repeated login errors (e.g., three consecutive login attempts and failures) will result in the user from further attempting to login and a notice to a system administrator and the user of the three unsuccessful login attempts.

Providing various user classes further restricts user access rights. User classes include plan participants, system administrators, system managers, and a demonstration user. Plan participants are illustratively current or past enrolled employees who typically are the main users of the system 100. System administrators manage the user business objects including the participants, plan, and communications. System managers have access to management reporting functions of the system 100, while demonstration users are those users who are limited to a demonstration program of the plan and its features. Accordingly, the user class system provides additional security by limiting access to specific features of the system 100.

Other, various security measures may be implemented to safeguard the system and user from privacy and against tampering of records. In one embodiment, all Internet hypertext transport protocol (http) data is encrypted. For example, the system may implement a Secure Sockets Layer (SSL), which is a protocol created by Netscape Corporation for managing the security of message transmissions over the Internet. One skilled in the art can envision other encrypting techniques to secure the transfer of information over the Internet. Further security measures may include user session timeouts after a predetermined time of inactivity, non-access to new users until the new user is verified by an administrator, and the like.

Referring to FIG. 6A, after logging in to the plan home page in step 604, the method 600 proceeds to step 606. In step 606, a communications viewer is presented to the participant. In step 608, the communications viewer displays all relevant plan documents and/or communications sent to the plan participant. These documents and communications may be relevant to a particular class of plan participants or to all of the employees or participants of a particular plan sponsor. Furthermore, the plan sponsor or the plan administrators define the relevancy of any plan communication medium (e.g., document, notification, and the like) in accordance to the federal, state, and agency laws, and plan sponsor policies. While the communications viewer is not strictly a part of the site hierarchy, the communications viewer is utilized to allow the plan participants to retrieve unread documents and communications. The user of this inventive system 100 is prohibited from proceeding to any of the lower tier web pages until all of the unviewed documents and/or communications have been selected for review by the user.

In step 610, the documents and communications are listed, for example, in chronological order of delivery, and are identified as having been either “read” or “unread”. In step 612, the user must select (e.g., click on a “read” button) each unread document or communication deemed relevant to satisfy the requirements of not having any unread documents or communications before proceeding to the lower tier web pages. That is, only those forced delivered documents deemed relevant by the plan sponsor must be read prior to proceeding to the lower tier web pages. In step 614, the user confirms that the selected document or communication has been viewed. Alternately, the user may print or download the documents and/or communication to satisfy such requirement (shown in phantom in step 616).

The method then proceeds to step 618, where the system determines whether any other listed documents and communications remain in an unread condition. If, in step 618, the determination is answered affirmatively, then the method 600 proceeds to step 612, and continues through step 618, until the determination is answered negatively. Otherwise, the user is logged off after some period of time and in step 632, an event trigger notifies a system administrator regarding the unread, forced delivered document. Thereafter, in step 634 a hard copy of the notification is delivered manually to the participant, already pre-configured on the system.

If, however, in step 618, the determination is answered negatively, then the method 600 proceeds to step 620. In step 620, the user is returned to the home page and permitted to proceed to the lower tier web pages to view or search information regarding the user's plan or benefits.

Referring to FIG. 6B, in step 620, the user may select from the home page a number of options such as a profile request, a plan request, and a document request. If the profile request is selected, the method 600 proceeds to step 622 and displays a profile web page wherein a user may access, download, and/or modify their user profile (e.g., user name, address, social security number, and other personal identification information). If a plan request is selected, the method 600 proceeds to step 624. In step 624, the method 600 displays plans web page, where a user can access, view, search, and/or download plan descriptions. If a document request is selected, the method 600 proceeds to step 626 to view a document web page, which provides a list of documents that can be viewed or downloaded by the user. At step 628, the method 600 queries whether additional selections are to be made. If the query is affirmatively answered, the method 600 proceeds to step 620; otherwise, in step 630 is requested to log off, and method 600 ends at step 636.

The web pages of the present invention are designed to be user friendly by maximizing viewing areas and provide ease of navigation. The web site for each plan is structured in a hierarchical format beginning with a home page and linking, via a plurality of menus and/or hyperlinks, to subsystem web page views.

Furthermore, the method 600 is provided with the capability to determine whether there are any documents or communications that remain unread for a time exceeding some predetermined period due to user inactivity or failure to access the plan web site. The predetermined period may be a global standard time for all the unread messages. Alternately, the predetermined period may be based upon the user class, priority, or urgency of the document or communication. Surpassing the predetermined period is an event trigger. The event trigger is programmed to automatically notify a plan administrator to send the plan participant a hard copy of the plan communications medium, for example, by mail or courier. Alternately, the event trigger automatically sends a second e-mail to the plan participant prior to notifying the plan administrator. If the plan participant is unresponsive to the second e-mail after a second predetermined period of time, then the plan administrator is notified of the system's automatic delivery and recordation of hard copy to the participant without human intervention.

In this manner, the system 100 ensures that a user is automatically notified of any new plan information generated, by utilizing the trigger event database 202 and, more importantly, the system ensures the employer that a federally-mandated document is indeed delivered to the participant, as is required by law. Moreover, where the user is delinquent or does not have access to the Internet, the system 100 automatically provides hard copy documents and/or communications to the plan participant without any interaction of a human resource administrator.

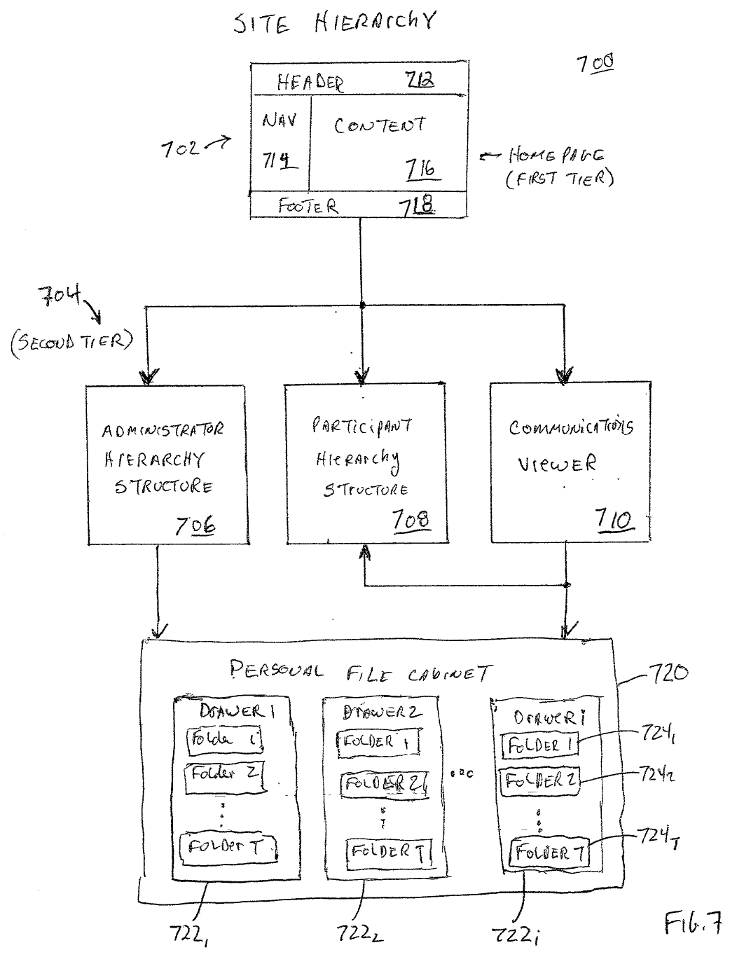

FIG. 7 depicts a block diagram of a hierarchical plan structure 700 of the present invention. The hierarchical plan structure 700 is embodied in a plan web site of the present invention, which is proprietary and unique to a particular entity such as a corporation, governmental agency, or any other facility that provides one or more employee benefit programs for the particular entity's employees, owners, families, and the like. A particular entity's plan web site may be installed at the entity's facilities or hosted by a service provider on the illustrative system 100 as shown in FIG. 1.

In one embodiment, the plan web site comprises a plurality of web pages, which are accessed in a hierarchical order for categorizing plan information. The web pages are written in HTML, which is displayed in a web browser format such as a NETSCAPE® browser or a MICROSOFT INTERNET EXPLORER® browser. The information is presented in various tiers beginning with general information at a plan home page 702 and progressively provides more categories and detailed information as the user accesses lower tiered web pages.

The plurality of web pages are designed with the same format throughout the hierarchical structure, thereby providing consistency so that the users may become easily acclimated to navigating through system. For example, in one embodiment a plan home page 702 and respective lower-tier web pages 704 each comprise a header section 712, a footer section 718, a navigation menu section 714, and a main contents section 716. The header section 712 is located on the top of the web page and is used to display the product and/or particular entity logo. The footer section 718 is located on the bottom of the web page and is used to display optional information according to each client's preferences for the plan. The navigation menu section 714 is located on the left side of the page. The navigation menu section 714 of the home page 702 illustratively contains a login form having input elements for the participant's user name, ID number, personal identification number (PIN), password, help button, and the like (not shown). The main content section 716 displays informational or welcome messages concerning client-specific information and any other viewable content material. As such, each web page 700 contains information concerning the current participant, plan, and state of a user's session. Furthermore, one skilled in the art may envision other embodiments of the web pages that provide viewing and navigational capabilities.

Referring to FIG. 7, the hierarchical structure illustratively depicts the home page 702, which is a first tier page, and three lower tier web pages 704, which are categorizes as second tier web pages. From the home page 702, the user may select and view lower tier web pages 704, such as one or more administrator web pages 706, participant web pages 708, and a communications viewer 710, which allows an administrator or participant to view documents and notices sent by the system 100. Furthermore, when available, links to other web pages (i.e., third tier information) may be optionally selected and viewed from each of the second tier web pages, and so on down the hierarchical system structure. As such, a user may navigate up and down the hierarchical structure to view plan information and notifications as required.

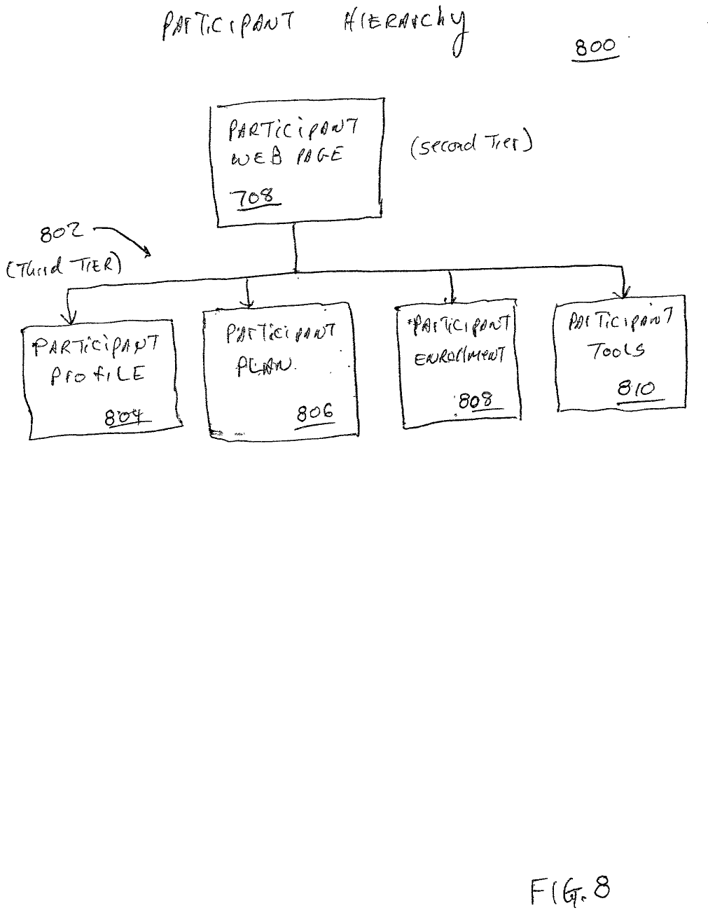

FIG. 8 depicts a block diagram of a hierarchy for a participant structure of the hierarchical plan structure of FIG. 7. In particular, the participant web page 708, which is located in the second tier of FIG. 7, is illustratively linked to four third tier web pages 802 containing plan information from which a user may select. These third tier web pages 802 include a participant profile web page 804, a participant plan web page 806, a participant enrollment web page 808, and a participant tools web page 810.

The participant profile web page 804 allows a participating user to access web pages (e.g., fourth tier and progressively other lower tier web pages) associated with viewing and managing their currently stored plan profiles. The participant profile may contain information such as name, address, date of birth, dependent information, email address, contact information, and any other relevant employee and plan information. A main navigation menu allows a user to view or update their current profile, as well as change a personal identification number (PIN). When a user updates his or her profile, the system will only allow read access of the profile information by another user while the profile is being updated. During the update, the current profile is copied and saved. The user is presented with fields containing the current information, which may be modified. Once the profile information is modified, the user “clicks” on an update button to save the information to a new update file. In a deferred update scenario, the update file is sent to an administrator for review and update. In a real-time scenario, the previous profile information is archived and the new update file is sent to the storage server, which becomes the “new” current profile information.

The participant plan web page 806 is an entry point for allowing a participant to access the web pages associated with displaying and managing the plans for which they are currently eligible, as well as any communications associated with each plan. A list of eligible plans associated with a participant (that is, only those plans relevant to the particular employee) is presented so that the user may “drill-down” to the plan's general information, communications, and optional external account access. The communications displayed under each plan's page are only those which are common to the plan, are eligible for the participant to view, and which the participant has read or viewed using the communications viewer 710.

The web pages associated with certain types of plans and communications that can be managed under the system 100 may include 401(k) plans, stock option plans, health plans, and the like. The aforementioned employee benefit plans are mentioned for illustrative purposes only and should not be considered as limiting. Additional plans may include pension plans, portfolio analysis, HR programs, or any other plan or program deemed desirable by a plan sponsor. Eligibility for each plan is determined on a plan-by-plan basis and pre-configured into the system, and each user must meet all eligibility requirements as defined under each plan in order to have access via the plan page. Plan communications may include static HTML communications, such as a plan summary, summary plan description, plan eligibility rules, schedules, frequently asked questions; forms, such as enrollment, investment election, beneficiary designation, and the like; and template communications, such as letters, personalized notifications, stock option awards or agreements, and the like. These plan web pages are static HTML. As such, no server-side processing is required for any elements associated with the plan pages.

The participant enrollment web page 806 allows the user to display, manage and enroll in various health (e.g., medical, dental, and vision), insurance and disability plans (e.g., long-term disability, flexible spending accounts), and any other benefit plans deemed desirable by the plan sponsor, and which the user may be currently eligible. In one embodiment, the enrollment page 806 becomes active and available during a pre-defined enrollment period, and provides a central location for the most current benefit communications and enrollment forms. Eligibility is determined on a benefit-by-benefit basis, and each user must meet all eligibility requirements as defined under each benefit in order to have access via the enrollment page 806.

The participant tools 810 provide the user with a set of basic tools for managing their benefits and communications. Each tool is singular in function and allows the user to quickly find and extract the necessary information from their plan or benefit documentation. In the event that the tools are unable to provide a definitive answer for the participant, the system 100 provides links to the plan documentation or a benefit administrator on each web page of the particular plan.

The participant tools 810 include a communications search tool and a historical archive of documents and communications. The communications search tool permits a participant to search through documents and communications based on one or more words or phrases pertaining to a particular plan or benefit. A result list is generated where some of the results may be hyper-linked to the actual document or communication for in depth review. Searches are performed, for example, by a search engine using database development software such as COLD FUSION®, manufactured by Allair LLC, which allows for full-text indexing and search capability of documents and data sources. Such search engines are well known in the art, and are discussed herein for completeness.

The historical archive allows a participant or user to access and isolate each historical document and communication. A historical document or communication is one that has been delivered as a result of a plan event and viewed by the participant with the communications viewer, or one that is available to be viewed regardless of eligibility in the relevant plan or benefit such as the summary plan document. In addition, the archived documents are stored in the system to allow the plan sponsor to retrieve and re-create such documents upon request, to illustratively satisfy any governmental or agency legal requirements.

Referring to FIG. 7, a “Personal File Cabinet” (PFC) 720 is optionally available on the web site for access by the participants and the plan administrators. The PFC 720 provides instant access to current and historical plan, benefit, and other communications. The PFC functions as a personal assistant, which keeps complete audit trails for documents based on who sent such document, who viewed the document, and what the document looked like. In particular, the PFC 720 keeps an archive of all relevant HR documents that have ever been issued to a participant. All documents issued to any given participant are automatically archived, including blank forms (for example, a blank Form W-4). The audit information contains time, date, IP address, user ID, as well as customized document related information.

An administrator of the plan sponsor or employer controls the PFC. The plan sponsor or employer administrator controls what is designated as a relevant document for archival purposes. A document marked as “archive” is kept in the system database and PFC permanently. A document non-archived marked document is stored in the system database only. In one embodiment, documents are marked as “archive” by default. Where a non-archived marked document is sent, only the most recent version of such document is kept in the PFC. Furthermore, non-archived documents may be edited, such as, a health benefits request form.

The PFC 720 includes a at least one drawer 722_{I} having at least one folders 724_{T}. Each drawer 722 is labeled and organized with similar documents. For example, the PFC 720 may have drawers 722 labeled “Health Benefits”, “Retirement Benefits”, “Other Insurance Benefits”, “Other HR Notices”, and the like. The folders 724 represent a subcategory for documents in each drawer 722. As such, the participant is presented with an organized history of all relevant communications that were sent to such participant.

While the participant web sites 708 provide static HTML web pages for delivering and tracking the processing of a communication, the administrator web pages 706 provide a dynamic interface for managing the plans, benefits, and communications associated with each plan or benefit in the system 100. As such, a human resource or third-party administrator is able to manage the parameters associated with each plan event related to document delivery and produce pre-defined or ad hoc reports based on these events.

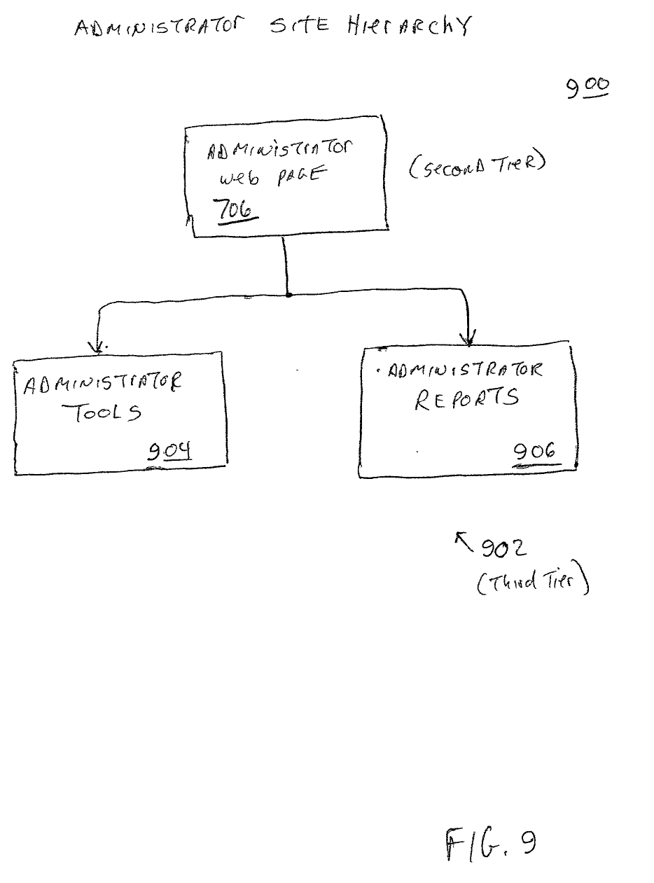

FIG. 9 depicts a block diagram of a hierarchy for an administrative structure of the hierarchical plan structure of FIG. 7. In particular, the administrator web page 706 are located in the second tier of FIG. 7, and are secured with administrator login procedures, password protection, and the like. The second tier administrative web pages 706 are illustratively linked to two third tier web pages 902 containing information from which an administrator may select. The third tier web pages 902 include an administrator tools web page 904 and an administrator reports web page 906. Any message sent by a service provider to the employer (such as a third party administrator) will be delivered through the forced delivery system as had by the participant; any documents viewed or unviewed by the plan administrator is similarly logged at the service provider's level.

The administrator tools web page 904 contains links to fourth tier web pages (not shown). These fourth tier web pages in the hierarchical structure include plan tools, which allow an administrator to add a new plan or modify existing plan information; communications tools, which allow an administrator to upload plan communications; and participant tools, which allow an administrator to add a participant or modify an existing participants status to an existing plan. This is done through a “wizard” type of inquiry (all pre-configured with the help of logic provided by Employee Benefits Consultants).

The administrator reports web page 906 also provides links to fourth tier web pages. The additional fourth tier web pages (not shown) provide an administrator with the capability of preparing and viewing, via the web pages, plan reports, communication reports, user defined reports and participant reports.

The system of the present invention rids employee benefit sponsors of most of the manual delivery, recordation, and physical storage of paper that currently burdens them. Thus, the delivery and recordkeeping costs relating to paper transactions are dramatically reduced, as are the overall cost of maintaining those plans. Plan sponsors employing the system will yield immediate visible bottom line savings. Plan sponsors also benefit from higher HR personnel productivity, as those personnel are able to focus instead on the core competencies of their business, policy issues, and more “big picture” business tasks. Higher productivity comes from the ability of the plan sponsor to instantly query any employee, employer, or plan service provider activity by plan type, participant, date, communication, viewed/unviewed status, and the like. The invention permits the mining of all data to produce instant and real-time reporting and monitoring capabilities.

Unlike the current regime of paper-intensive plan administration, HR personnel utilizing the system are relieved from spending any time in determining which employee needs which notice and when. Moreover, the sponsor is able to electronically document that a notice was sent consistent with federal and/or state mandate, with confirmed receipt. For plan administrators with participants lacking access to a computer, the system is accessible from “kiosks” at centrally located workstations. A kiosk, in a sense, is an automated teller machine (“ATM”) for employee benefit information, where, instead of viewing savings account and checking balances, the user sees for example, the balance in his retirement plan. Likewise, instead of moving money from a certificate of deposit (“CD”) to a checking account, the user moves eligible floating holidays from his vacation bank to his sick leave bank.

Finally, the system can identify which participant failed to access a computer or kiosk to receive and read a required notice, and then provide notice to the plan administrator indicating who must receive plan documents through other than automated means. Similarly, the system can identify if a plan administrator failed to access the system to receive and read a required notice sent by a service provider.

Although various embodiments that incorporate the teachings of the present invention have been shown and described in detail herein, those skilled in the art can readily devise many other varied embodiments that still incorporate these teachings.

What is claimed is:

1. A method for automatically identifying, distributing, recording, and re-creating communications electronically to selective participants of a plan, comprising:
providing a database containing plan and plan participant information;
defining a plurality of plan rules associated with plan and plan participant information;
defining a plurality of event triggers based on the plurality of plan rules;
determining if an event trigger initiates delivery of at least one plan communication medium;
determining a plan participant recipient listing;
providing access to view the at least one plan communication medium; and
confirming the selective participants have viewed the at least one plan communication medium.

2. The method of claim 1 wherein the defining a plurality of plan rules is performed by a plan sponsor.

3. The method of claim 1, wherein the defining a plurality of event triggers is defined by a programmer selected from the group comprising a plan sponsor and a plan administrator.

4. The method of claim 1 wherein the plan communications medium is selected from the group comprising a plan document, a plan form, a plan report, and a notification.

5. The method of claim 4 wherein the at least one plan communications medium is generated from the database.

6. The method of claim 1 wherein the determining the plan participant recipient listing comprises the step of initiating a message transmission module in an instance where the event trigger has occurred.

7. The method of claim 6 wherein the initiating step comprises the steps of:
identifying the at least one plan communications medium that is to be delivered; and
identifying at least one recipient of the at least one plan communications medium.

8. The method of claim 7 further comprising the step of electronically delivering the at least one plan communications medium automatically to the at least one recipient.

9. The method of claim 8 further comprising the step of manually delivering the at least one plan communications medium to the at least one recipient.

10. The method of claim 9 wherein the manual delivery step further comprises the steps of:
setting a predetermined period of time for the participants to read the at least one plan communications medium delivered electronically;
determining whether the at least one electronically delivered communications has been read by each participant;
initiating an event trigger in an instance where the at least one electronically delivered communications has not been read; and
notifying a plan administrator.

11. The method of claim 1 wherein the confirmation step further comprises the steps of:
enabling selected web site pages for viewing;
providing an electronic signature affirmation; and
receiving such electronic signature affirmation.

12. The method of claim 1 wherein the confirmation step further comprises the step of prohibiting the participants from viewing a plan web site in an instance where any of the at least one plan communication medium, which are deemed relevant, are not confirmed as being read by the participants.

13. The method of claim 12 wherein the prohibiting step further comprises the steps of:
requesting the plan participant to login to a plan web site;
presenting a communications viewer to the participant; and
enabling the plan participant to select and retrieve the at least one plan communications medium.

14. The method of claim 12 further comprising the step of permitting the plan participant access to the plan web site upon confirming that all of the relevant at least one plan communications medium have been read by the plan participant.

15. The method of claim 1 wherein the defining of the plurality of event triggers further comprises, storing in a trigger event database for each trigger event, an entry identification a trigger description, an associated plan communications medium, a trigger criteria, and trigger type.

16. A computer-readable medium having instructions or programs which, when executed by a process cause the process to perform a method for automatically distributing communications electronically to participants of a plan, comprising:
providing a database containing plan and plan participant information;
defining a plurality of plan rules associated with the plan and plan participant information;
defining a plurality of event triggers based on the plurality of plan rules;
determining if an event trigger initiates delivery of at least one plan communication medium;
determining a plan participant recipient listing;
providing access to view the at least one plan communication medium; and
confirming the selective participants have viewed the at least one plan communication medium.

17. The computer readable medium of claim 16, wherein the defining a plurality of event triggers is defined by a programmer selected from the group comprising a plan sponsor and a plan administrator.

18. The computer readable medium of claim 16 wherein the plan communications medium is selected from the group comprising a plan document, a plan form, a plan report, and a notification.

19. The computer readable medium of claim 18 wherein the at least one plan communications medium is generated from the database.

20. The computer readable medium of claim 16 wherein the determining the plan participant recipient listing comprises the step of initiating a message transmission module in an instance where the event trigger has occurred.

21. The computer readable medium of claim 20 wherein the initiating step comprises the steps of:
identifying the at least one plan communications medium that is to be delivered; and
identifying at least one recipient of the at least one plan communications medium.

22. The computer readable medium of claim 21 further comprising the step of electronically delivering the at least one plan communications medium automatically to the at least one recipient.

23. The computer readable medium of claim 22 further comprising the step of manually delivering the at least one plan communications medium to the at least one recipient.

24. The computer readable medium of claim 23 wherein the manual delivery step further comprises the steps of:
setting a predetermined period of time for the participants to read the at least one plan communications medium delivered electronically;
determining whether the at least one electronically delivered communications has been read by each participant;
initiating an event trigger in an instance where the at least one electronically delivered communications has not been read; and
notifying a plan administrator.

25. The method of claim 16 wherein the confirmation step further comprises the steps of:
enabling selected web site pages for viewing;
providing an electronic signature affirmation; and
receiving such electronic signature affirmation.

26. The computer readable medium of claim 16 wherein the confirmation step further comprises the step of prohibiting the participants from viewing a plan web site in an instance where any of the at least one plan communication medium, which are deemed relevant, are not confirmed as being read by the participants.

27. The computer readable medium of claim 26 wherein the prohibiting step further comprises the steps of:
requesting the plan participant to login to a plan web site;
presenting a communications viewer to the participant; and
enabling the plan participant to select and retrieve the at least one plan communications medium.

28. The computer readable medium of claim 26 further comprising the step of permitting the plan participant access to the plan web site upon confirming that all of the relevant at least one plan communications medium have been read by the plan participant.

29. The computer readable medium of claim 16 wherein the defining of the plurality of event triggers further comprises, storing in a trigger event database for each trigger event, an entry identification, a trigger description, an associated plan communications medium, trigger criteria, and a trigger type.

30. An apparatus, for automatically distributing, recording, monitoring, and re-creating communications electronically to participants of a plan, comprising:
a server providing a plan database,
a plurality of event triggers associated with the plan database;
a plurality of plan communications medium associated with the plan database and the plurality of event triggers;
a transmission module coupled to the plan database;
a plurality of plan participant computers and
a communications network coupled to the server and plurality of plan participant computers, wherein at least one of the plurality of plan communications medium are provided electronically to at least one of the plurality of plan participant computers in an instance where at least one of the plurality of event triggers is initiated.

31. The apparatus of claim 30 wherein the communications medium (208) is selected from the group comprising plan documents, plan forms, plan reports, and plan notifications.

32. The apparatus of claim 30 wherein the at least one communication medium is generated from the database.

33. The apparatus of claim 30 wherein the communications network is selected from the group comprising the Internet, Intranet, local area network, and wide area network.

34. The apparatus of claim 30 wherein the plurality of event triggers further comprises, for each trigger event, an entry identification, a trigger description, an associated plan communications medium, a trigger type, and a trigger criteria.

35. The apparatus of claim 34 further comprising a plan web site.

36. The apparatus of claim 35 wherein the plan web site comprises a plurality of web pages having a hierarchical structure.

37. The apparatus of claim 36 wherein the web site provides connectivity to an administrator hierarchy of web pages, a participant hierarchy of web pages, and a communications viewer.

38. The apparatus of claim 37 wherein the communications viewer provides plan participant access to read the delivered at least one plan communications medium.

39. The apparatus of claim 38 wherein the communications viewer further comprises a personal file cabinet.

40. The apparatus of claim 39 wherein the personal file cabinet permanently stores archived communication medium unique to each of the participants and, further, unique to an employer.

41. A method for automatically distributing plan communications electronically to participants of a plan comprising:
sending an electronic mail communication inviting access to a web site;
waiting for access to the web site for a predefined period of time; and
sending an alternate communication after the predefined period of time has surpassed.

42. The method of claim 41 wherein the waiting step further comprises the step of receiving a confirmation from the participants of the plan having viewed the communications.

43. The method of claim 42 wherein the receiving the confirmation step further comprises receiving an electronic signature.

44. The method of claim 41 further comprising the step of permitting the participants having confirmed viewing the plan communications to access additional plan web pages.

45. The method of claim 41 wherein prior to said sending an alternate communication, the method further comprises:
sending a second electronic mail communication; and
waiting for access to the web site for a second predefined period of time.
